(19) United States
(12) Patent Application Publication
(10) Pub. No.: US 2009/0076931 A1
(43) Pub. Date: Mar. 19, 2009

(54) Method of using wireless communication device to tender for remaining seats of higher class in a transportation tool which is about to depart or has just departed

(76) Inventor: ChiChung Hung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/292,489

(22) Filed: Nov. 20, 2008

Related U.S. Application Data
(63) Continuation of application No. 10/848,142, filed on May 19, 2004, now abandoned.

(51) Int. Cl. G06Q 30/00

(52) U.S. Cl. 705/26

(57) ABSTRACT

A method of using wireless communication device to tender for remaining seats of higher class in a transportation tool which is about to depart or has just departed. The method includes steps (a) to (e). In step (a), before or after the transportation tool departs, the transportation company transmits data of remaining seats of higher class to an Internet auction website or an auction website on a wireless communication network. In step (b), before or after the transportation tool departs, authorized passengers start tendering for the remaining seats via the wireless communication network. In step (c), the passengers winning the remaining seats pay the difference with a credit card through a terminal of the wireless communication network or directly pay the difference to a serviceman. In step (d), after paid, a passenger seat list is changed and transmitted to the transportation company. In step (e), the transportation company transmits the data of successful switch of seats back to the transportation tool for a serviceman to lead the passengers to new seats.

### CROSS-REFERENCE TO RELATED APPLICATION

This application is a Continuation-In-Part of U.S. patent application Ser. No. 10/848,142 filed May 19, 2004, and entitled, “Method for tendering for remaining seats of higher class in an airliner which is about to take off or has just taken off”.

### BACKGROUND OF THE INVENTION

The present invention is related to a method of using wireless communication device to tender for remaining seats of higher class in a transportation tool which is about to depart or has just departed, and more particularly to a method of tendering for remaining seats of higher class in a transportation tool which is about to depart or has just departed via wireless communication network trade platform.

It is known that in a higher-level transportation tool (such as a high speed train or an airliner), generally there are first class cabin, business class cabin and economy class cabin. It often takes place that after the transportation tool departs, many vacancies are left in the first class cabin and business class cabin without being utilized during whole travel. This leads to great loss to a transportation company and waste of resource.

To solve the above problem, this applicant's Taiwanese Patent Application No. 90133276, filed on Dec. 31, 2001, discloses a method for tendering for remaining seats of higher class in an airliner which is about to take off or has just taken off. By means of this method, the better seats on the airliner can be more effectively utilized to increase income of the airline and avoid waste of resource. According to this method, the passengers with lower-class tickets will have a chance of being upgraded. This method is a value-added management method for the airline and is applicable to other transportation tools. Especially, wireless communication devices are widely used nowadays. The wireless communication devices can multiply the application effect of this method.

### SUMMARY OF THE INVENTION

It is therefore a primary object of the present invention to provide a method of tendering for remaining seats of higher class in a transportation tool which is about to depart or has just departed via wireless communication network trade platform.

The present invention can be best understood through the following description and accompanying drawings wherein:

### BRIEF DESCRIPTION OF THE DRAWING

FIG. 1 is a flow chart of a preferred embodiment of the method of using wireless communication device to tender for remaining seats of higher class in a transportation tool which is about to depart or has just departed of the present invention.

### DETAILED DESCRIPTION OF THE PREFERRED EMBODIMENT

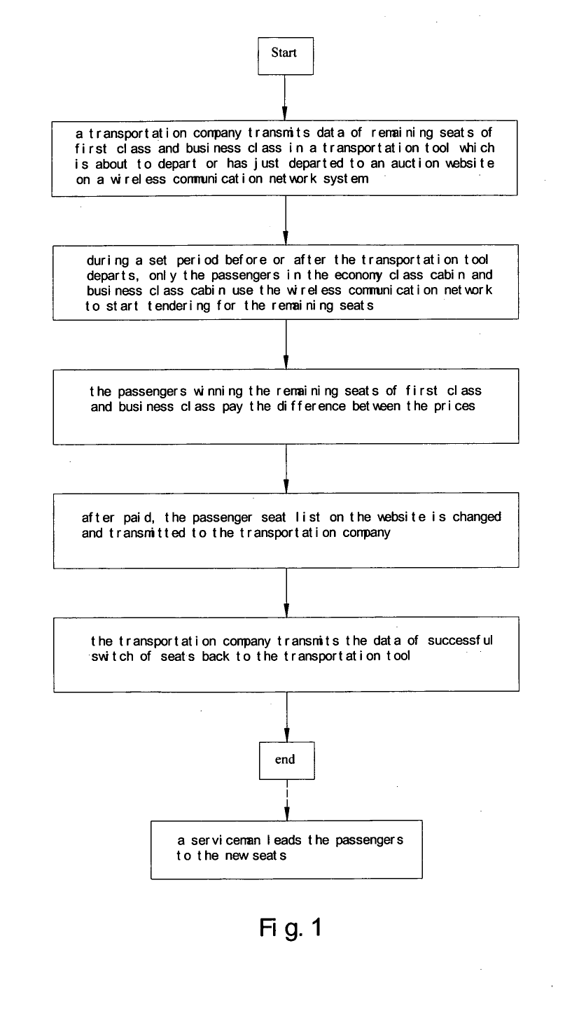

Please refer to FIG. 1. The method of using wireless communication device to tender for remaining seats of higher class in a transportation tool which is about to depart or has just departed of the present invention includes steps of:

step (a) in which the transportation company transmits the data of the remaining seats of higher class such as first class or business class in the transportation tool which is about to depart or has just departed to an Internet auction website or an auction website on a wireless (mobile) communication network;

step (b) in which during a set time period before or after the transportation tool departs, (such as the time for waiting for takeoff of an airliner or the time before a train or a boat departs or the time when the train or the boat navigates), the authorized passengers in the economy class cabin or business class cabin use the passengers' own wireless communication devices (such as mobile phones) via wireless communication network to start tendering for the remaining seats of higher class.

step (c) in which after the auction procedure is completed, the passengers winning the remaining seats pay the difference between the prices of the won seat and the original seat with a credit card through a terminal of the wireless communication network or directly pay the difference to a serviceman on the transportation tool;

step (d) in which after paid, the passenger seat list is changed and via the network transmitted to the transportation company for data processing;

step (e) in which the transportation company transmits the data of successful switch of seats back to the transportation tool to complete the auction process. When boarding the transportation tool, a serviceman leads the passengers winning the remaining seats to the new seats.

In the above method, the difference paid by the passenger is less than the original difference so as to attract the passenger to be upgraded.

In FIG. 1, in step S100, that is, step (a), before or after departing, the transportation company transmits the data of the remaining seats of the transportation tool to a wireless communication network system or any other equivalent. The wireless communication network system can be Internet or any wireless communication network. In step S102, that is, step (b), a public auction process on the network is performed. In step S103, that is, step (c), the auction winner passengers pay the difference.

In step S104, that is, step (d), after the auction process is completed, the data are transmitted to the transportation company for data confirmation and processing. In step S105, that is, step (e), the transportation company transmits the data of successful switch of seats to the transportation tool to complete the auction process. Then the serviceman on the transportation tool proceeds to complete the final procedure.

According to the above method, the better seats on the transportation tool can be fully economically utilized to avoid vacancy of the seats of high class and waste of resource. The existent popular and advanced wireless communication devices can greatly enhance the application effect of the method of the present invention.

The above embodiment is only used to illustrate the present invention, not intended to limit the scope thereof. Many modifications of the above embodiment can be made without departing from the spirit of the present invention.

What is claimed is:

1. A method of tendering for remaining seats of higher class in a transportation tool which is about to depart or has just departed via wireless communication network trade platform, said method comprising steps (a) to (e), wherein:
in step (a), during a set time period before or after the transportation tool departs, the transportation company transmits data of remaining seats of higher class such as first class or business class to a wireless communication Internet auction website or an auction website on a wireless communication network;
in step (b), during a set time period before or after the transportation tool departs, authorized passengers in economy class cabin or business class cabin publicly start tendering for the remaining seats of higher class;
in step (c), after the auction procedure is completed, the passengers winning the remaining seats pay the difference between the prices of the won seat and the original seat;
in step (d), after paid, a passenger seat list is directly changed and transmitted to the transportation company for data processing; and
in step (e), the transportation company transmits the data of successful switch of seats back to the transportation tool to complete the upgrade auction process, a serviceman on the transportation tool then leading the auction winner passengers to the auctioned off seats.

2. The method as claimed in claim 1, wherein in step (b), the auction process is performed via wireless communication network system.

3. The method as claimed in claim 1 or 2, wherein in step (c), the difference is paid with a credit card through a terminal of the wireless communication network.

4. The method as claimed in claim 1 or 2, wherein in step (c), the passengers winning the remaining seats directly pay the difference to a serviceman on the transportation tool.

5. The method as claimed in claim 1 or 2, wherein in step (c), the difference paid by the passengers is less than the original difference.

6. The method as claimed in claim 3, wherein in step (c), the difference paid by the passengers is less than the original difference.

7. The method as claimed in claim 4, wherein in step (c), the difference paid by the passengers is less than the original difference.
